(19) United States
(12) Patent Application Publication
(10) Pub. No.: US 2004/0148177 A1
(43) Pub. Date: Jul. 29, 2004

(54) Method and apparatus of audio performance

(76) Inventors: Yung-Chiuan Weng, Taipei (TW); Chu Hung-Yi Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/351,550

(22) Filed: Jan. 27, 2003

(51) Int. Cl. G10L 21/00

(52) U.S. Cl. 704/278

(57) ABSTRACT

The performance method of audio effect is executive of application software in company with an output device. A referring signal indicative of a genre of a digital audio signal is provided. A DSP engine accepts the referring signal to process the referring signal and to produce a genre command. The output device accepts the genre command to synchronically perform an audio effect. Apparatus of audio performance includes a digital signal processor engine, an output circuit, and audio output device. The DSP engine, definitive of accepting a referring signal, is configured to produce a genre command in accordance with the referring signal. The output circuit is configured to accept the genre command and process an audio effect of the genre in accordance with the genre command. The audio output device is configured to perform the audio effect of the genre without manual settings.

### BACKGROUND OF THE INVENTION

This invention relates to a method and apparatus of audio performance, and more particularly to a method and apparatus of digital audio performance.

### BACKGROUND OF THE INVENTION

Digital-audio systems are becoming more commonplace in personal computers. A digital-signal processor (DSP) or the main microprocessor or central processing unit (CPU) of a PC can be used to modify digital audio signals.

FIG. 1 is a schematic flowchart illustrating the performance of audio effect in the prior art. A computer or a playback (step 110) loads an audio source file. The audio source file includes digital audio data and tag information. However, the tag information, including a genre for the digital audio data, is generally ignored or just displayed on a display screen. Next, a decoder is used to decode the digital audio data (step 112). A DSP, connecting with the decoder, is configured to process the decoded digital audio data (step 114). Through manually selecting an audio effect of the digital audio data (step 116), an output device connecting with the DSP, performs the audio effect in light of manual selection by an operator (step 118).

However, it is necessary to manually select the audio effect of the digital audio data in a conventional setting for the performance of audio effect, which is uncomfortable and inflexible for the operator who may not understand very well the types of audio effect.

### SUMMARY OF THE INVENTION

The methods and apparatus of the present invention address many of the shortcomings of the prior art. It is a principal object of the present invention to provide a method and apparatus of audio performance. The genre of an audio source file is used to control the performance of an audio output device.

It is another object of the present invention to provide a method and apparatus of audio performance in connection with a computer. The audio effect of an audio source file can be performed without manual settings.

In accordance with an exemplary embodiment of the present invention, the performance method of audio effect is executive of application software in company with an output device. A referring signal indicative of a genre of a digital audio signal is provided. A digital signal processor engine accepts the referring signal to process the referring signal and to produce a genre command in connection with the genre. The output device accepts the genre command to perform an audio effect in company with the digital audio signal. Apparatus of audio performance includes a digital signal processor engine, an output circuit, and audio output device. The digital signal processor engine, definitive of accepting a referring signal indicative of a genre, is configured to produce a genre command in accordance with the referring signal. The output circuit, connecting with the digital signal processor engine, is configured to accept the genre command and process an audio effect of the genre in accordance with the genre command. The audio output device, connecting with the output circuit, is configured to perform the audio effect of the genre without manual settings.

### BRIEF DESCRIPTION OF DRAWINGS

The foregoing and other objects, features, and advantages of the invention will become more readily apparent upon reference to the following detailed description of a presently preferred embodiment, when taken in conjunction with the accompanying drawings in which like numbers refer to like parts, and in which:

FIG. 1 is a schematic flowchart illustrating the performance of audio effect in a prior art;

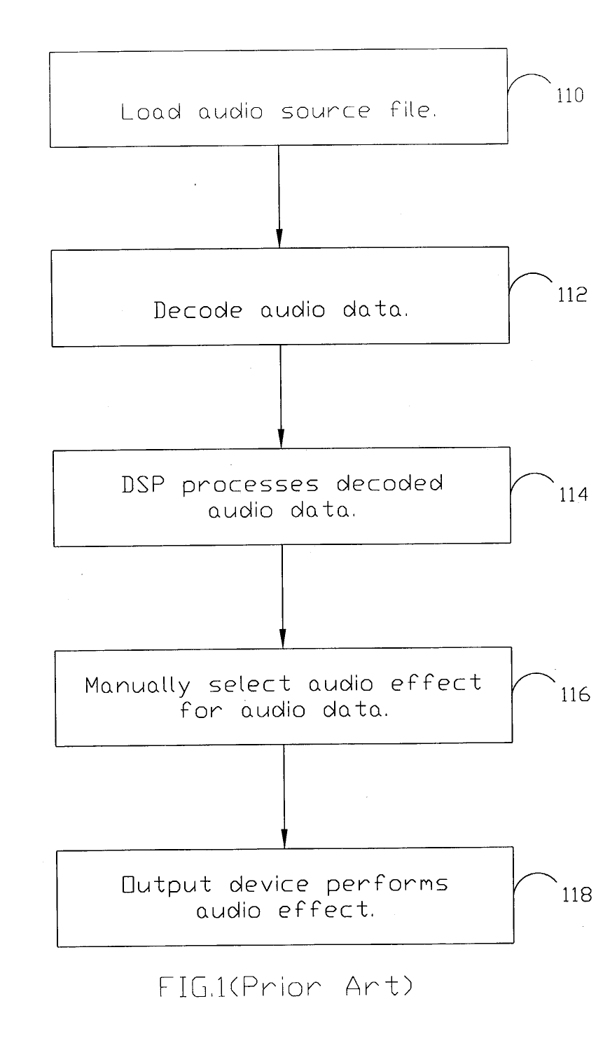

FIG. 2 is a schematic flowchart illustrating the performance method of output device in reference to the genre of a digital audio signal in accordance with the present invention; and

FIG. 3 is a schematic diagram illustrating hardware arrangement of audio performance apparatus in accordance with the present invention.

### DETAILED DESCRIPTION OF THE INVENTION

An appropriate and preferred embodiment will now be described in the form of an electronic audio apparatus that performs an automatic accompaniment or automatic playing (hereafter referred to simply as automatic playing). It should be noted, however, that this embodiment is merely an example and can be variously modified without departing from the scope of the present invention.

The present invention provides a performance method and apparatus of audio performance. A performance method of audio effect for an audio effect is executive of application software in company with an audio output device. A digital audio source file is loaded, which stores digital audio data and tag information. The tag information including information of a genre in the digital audio source file is then retrieved. The information of the genre is translated in light of a predetermined specification in relation to the digital audio source file. A referring signal indicative of said genre is sent to a digital signal processor engine. A genre command is produced in accordance with the referring signal accepted by the digital signal processor engine. Then audio output device accepts the genre command to perform an audio effect in company with the digital audio data. An apparatus of audio performance includes a digital signal processor engine, an output circuit, and audio output device. The digital signal processor engine, definitive of accepting a referring signal indicative of a genre, is configured to produce a genre command in accordance with the referring signal. The output circuit, connecting with the digital signal processor engine, is configured to accept the genre command and process an audio effect of the genre in accordance with the genre command. The audio output device, connecting with the output circuit, is configured to perform the audio effect of the genre without manual settings.

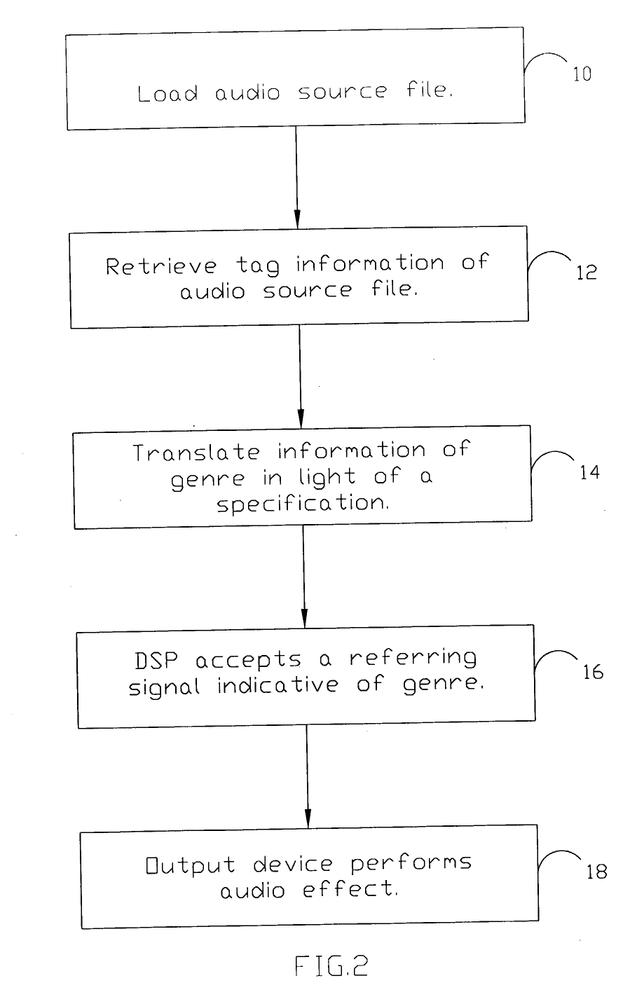

FIG. 2 is a schematic flowchart illustrating the performance method of output device in reference to the genre of a digital audio signal in accordance with the present invention. In the present invention, a computer or a playback (step 10) loads an audio source file. The audio source file can be stored in any storage device that is embedded in or connected with the computer or the playback. Furthermore, the audio source file includes digital audio data and tag information. In general, the computer or a playback in accordance with any corresponding digital audio format decodes the digital audio data, such as voice or music data.

On the other hand, the tag information is retrieved from the audio source file (step 12). A genre in relation to the digital audio source file is included in the tag information. Then the information of genre, as well as the tag information, is analyzed by a tag analyzer and translated in light of a predetermined specification in correspondence to the digital audio format (step 14) to send a referring signal. In general, each piece of information of genre is corresponding to each audio effect. If the information of genre is not referred to any existing audio effect that an output device or the playback can provide, the information of genre is classified as a predetermined audio effect, such as a “normal” audio effect. Alternatively, the genre without reference to any existed audio effect could be classified null to send the referring signal indicative of null genre.

The referring signal indicative of the genre is accepted by a digital signal processor (DSP) engine embedded in or connected with an output device (step 16). It is understood that the decoded audio data could be sent to a DSP engine for further processing if necessary. Next, in the present invention, the DSP engine produces a genre command in connection with the genre indicated by the referring signal, and further, directly sends the genre command to the output device in relation to performance of audio effect (step 18). Without external or user manipulation, the output device, which may include tone generators, equalizers, amplifiers, or speakers, automatically performs the audio effect in company with the digital audio signal.

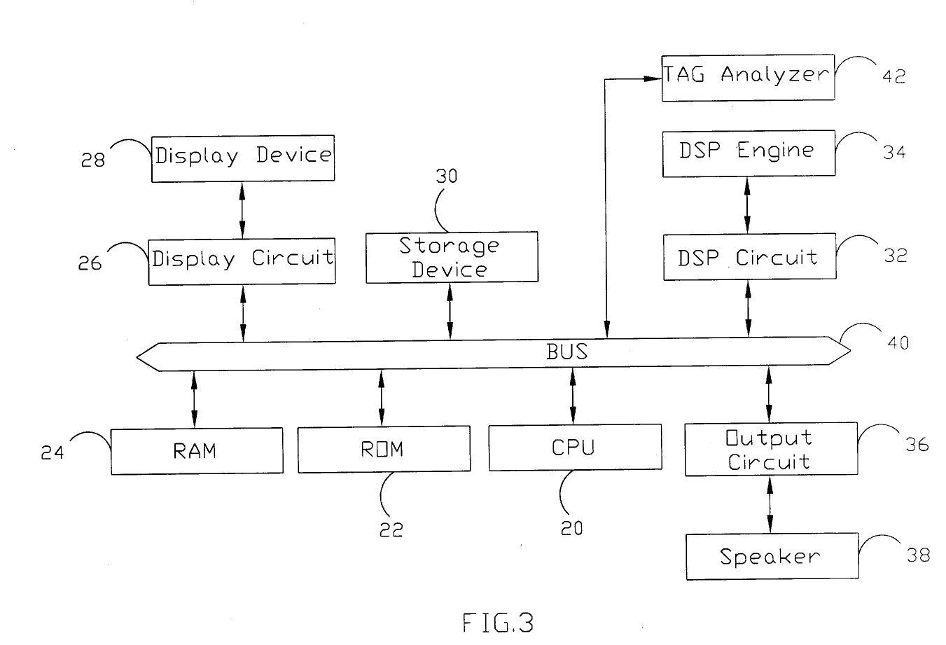

FIG. 3 is a schematic diagram illustrating the hardware arrangement of an audio performance apparatus in accordance with the present invention. In one embodiment, the audio performance apparatus is executed in connection with a personal computer having a central processing unit (CPU) 20, a read only memory (ROM) 22, a random access memory (RAM) 24, a display circuit 26, a display device 28, and a storage device 30. The audio performance apparatus includes a DSP engine 34, a DSP circuit 32, an output circuit 36, and a speaker 38. The audio performance apparatus also further includes a tag analyzer 42. The audio performance apparatus of the present invention connects with the personal computer through a bus 40. The tag analyzer 42 communicates with the DSP engine 34 through the bus 40. Alternatively, the audio performance apparatus can also be embedded into the personal computer and communicates to the personal computer through any suitable peripheral circuit. And the tag analyzer 42 could also communicate with the DSP engine 34 through the peripheral circuit. On the other hand, DSP circuit 32 can be integrated together with the output circuit 36 without limitation to FIG. 3.

In the embodiment, the CPU 20 controls various functions in light of predetermined programs. The ROM 22 stores the predetermined programs for controlling the personal computer. It is understood that some programs relative to control basic processing for audio performance apparatus can be stored in the ROM 22 if necessary. The RAM 24 is used as a work area for storing various parameters, such as a predetermined specification in relation to a format of audio source file. The storage device 30, such as a hard disk drive (HDD), a floppy disk drive (FDD), a compact disk read only memory (CD-ROM) drive, a magneto-optical (MO) disk driver, or a multi-purpose digital video disk (DVD) drive stores programs relative to the execution of the personal computer. The audio source files in the present invention can be stored in the storage device 30. Alternatively, the storage device 30 also can include CD in a player or a playback. Through the display circuit 26, the display device 28 is used for displaying a title of audio effect in relation to the audio source file. Furthermore, the tag analyzer 42 could be another ROM or suitable IC for storing the programs for analyzing the tag information. The predetermined specification could also be stored in the tag analyzer 42.

FIG. 3 illustrates the present invention in connection with FIG. 2. A digital audio source file with MP3 (Moving Picture Experts Group Audio Layer 3) format is stored or loaded in the storage device 30. The tag information in the digital audio source file is retrieved and sent to the tag analyzer 42. The tag analyzer 42 searches some bytes of tag information for the genre of the music, such as digital “8”. Then the digital “8” is further translated or looked-up in light of ID3 specification for MP3 format. The digital “8” corresponds to the ID3 specification that represents “Jazz”. A referring signal indicative of “Jazz” is sent to the DSP engine 34 through a pin definitive of accepting the referring signal. DSP engine 34 processes referring signal and produces a genre command of “Jazz”. Connecting the DSP circuit 32 and the output circuit 36 through the bus 40, the genre command of “Jazz” is sent to the output circuit 36 for processing a “Jazz” audio effect of the speaker 38. Without manually setting or operating in the present invention, the speaker 38 could perform the “Jazz” audio effect automatically and synchronically. It is noted that the speaker 38 can choose to perform a “normal” audio effect if the genre command indicates a null genre when the genre in the tag information is not corresponded to a suitable genre. Alternatively, the speaker 38 would choose to perform a predetermined, such as “normal”, audio effect if the output circuit 36 or the speaker 38 does not recognize the genre command.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

We claim:

1. A performance method of audio effect executive of application software in company with an output device, said performance method of audio effect comprising:
providing a referring signal indicative of a genre of a digital audio signal;
accepting said referring signal by a digital signal processor engine to process said referring signal and to produce a genre command in connection with said genre; and
accepting said genre command by said output device to perform an audio effect in company with said digital audio signal.

2. The performance method of audio effect in accordance with claim 1, wherein said providing step comprises:
retrieving a tag information from said digital audio signal, said tag information including an information of said genre;
translating said information of said genre in light of a predetermined specification; and
outputting said referring signal including said translated information of said genre.

3. The performance method of audio effect in accordance with claim 2, wherein said referring signal is a signal indicative of null genre when said information of said genre is translated not to be referred to said predetermined specification.

4. The performance method of audio effect in accordance with claim 3, wherein said output device performs a predetermined audio effect in light of said signal.

5. The performance method of audio effect in accordance with claim 1, wherein said genre command comprises a null command without connection with said genre.

6. The performance method of audio effect in accordance with claim 5, wherein said output device performs a predetermined audio effect by accepting said null command.

7. The performance method of audio effect in accordance with claim 1, wherein said output device comprises an equalizer in relation to performance of said audio effect.

8. A performance method of audio effect for an audio effect executive of application software in company with an audio output device, said performance method of audio effect comprising:
loading a digital audio source file, said digital audio source file storing digital audio data and a tag information;
retrieving said tag information including an information of a genre in said digital audio source file;
translating said information of said genre in light of a predetermined specification in relation to said digital audio source file;
sending a referring signal indicative of said genre to a digital signal processor engine;
producing a genre command in accordance with said referring signal accepted by said digital signal processor engine; and
accepting said genre command by said audio output device to perform an audio effect in company with said digital audio data.

9. The performance method of audio effect in accordance with claim 8, wherein said loading step further comprises:
retrieving said digital audio data;
decoding said digital audio data in accordance with a corresponding digital audio format; and
sending said decoded digital audio data to said digital signal processor engine.

10. The performance method of audio effect in accordance with claim 8, wherein said referring signal is a signal indicative of null genre when said information of said genre is translated not to be referred to said predetermined specification.

11. The performance method of audio effect in accordance with claim 10, wherein said output device performs a predetermined audio effect in light of said signal.

12. The performance method of audio effect in accordance with claim 8, wherein said genre command comprises a null command without connection with said genre.

13. The performance method of audio effect in accordance with claim 12, wherein said output device performs a predetermined audio effect by accepting said null command.

14. Apparatus of audio performance comprising:
a digital signal processor engine definitive of accepting a referring signal indicative of a genre, said digital signal processor configured to produce a genre command in accordance with said referring signal;
an output circuit connecting with said digital signal processor engine, said output circuit configured to accept said genre command and process an audio effect of said genre in accordance with said genre command; and
an audio output device connecting with said output circuit, said audio output device configured to perform said audio effect of said genre.

15. The apparatus of audio performance in accordance with claim 14, further comprising a tag analyzer connecting with said digital signal processor engine configured to retrieve a tag information and translate said tag information to produce said referring signal, said tag information including an information of said genre.

16. The apparatus of audio performance in accordance with claim 14, wherein said digital signal processor engine further comprises accepting said referring signal indicative of a null genre.

17. The apparatus of audio performance in accordance with claim 14, wherein said output circuit further comprises processing a predetermined audio effect when said genre command is indicative of a null genre.

18. Apparatus of audio performance in company with a computer, said apparatus of audio performance comprising:
a tag analyzer connecting with said computer, said tag analyzer configured to retrieve a tag information and translate said tag information to produce a referring signal, said tag information including an information of a genre for a digital audio file in said computer;
a digital signal processor engine definitive of accepting said referring signal indicative of said genre, said digital signal processor configured to produce a genre command in accordance with said referring signal;
an output circuit connecting with said digital signal processor engine, said output circuit configured to accept said genre command and process an audio effect of said genre in accordance with said genre command; and
an audio output device connecting with said output circuit, said audio output device configured to perform said audio effect of said genre.

19. The apparatus of audio performance in accordance with claim 18, wherein said computer further comprises decoding said digital audio file.

20. The apparatus of audio performance in accordance with claim 18, wherein said digital audio file further comprises stored in a disc read by said computer.
